(19) United States
(12) Patent Application Publication
(10) Pub. No.: US 2016/0098769 A1
(43) Pub. Date: Apr. 7, 2016

(54) System and Method for Providing Centralized Usage and Billing Information

(71) Applicant: Cloudian Holdings, Inc., Foster City, CA (US)

(72) Inventor: Sachin S. NAIK, Sunnyvale, CA (US)

(21) Appl. No.: 14/504,685

(22) Filed: Oct. 2, 2014

(51) Int. Cl. G06Q 30/04

(52) U.S. Cl. CPC G06Q 30/04

(57) ABSTRACT

A client-side cloud storage instance accesses a shared-access storage to retrieve a centralized usage and billing report relating to services provided by a plurality of service providers, including a cloud storage solution provider and one or more third party service providers. The centralized usage and billing report is automatically and periodically generated based on billing policy information received by the shared-access storage from the one or more third party services provider, and contains usage and/or billing information corresponding to services provided by both the cloud storage solution provider and by the one or more third party storage services providers.

### FIELD OF THE INVENTION

The present invention relates generally to providing usage and billing information to subscribers, and more particularly to providing centralized billing and usage information relating to services provided by a plurality of service providers.

### BACKGROUND OF THE INVENTION

Cloud storage is a model of data storage in which data is stored in logical pools or buckets, while the physical storage may span across multiple servers and even across multiple geographic locations. The physical environment (i.e., servers, network interfaces, etc.) is owned and managed by a hosting company. While cloud storage hosting companies can sometimes provide cloud storage services directly to subscribers, in many cases cloud storage solution providers are essentially interjected between the hosting company and the subscribers in order to offer a richer and more robust set of storage-related services.

The cloud storage services provided by such cloud storage solution providers may be accessed through a co-located cloud computing service, a web service application programming interface (API) or by applications that utilize the API, such as cloud desktop storage, a cloud storage gateway or Web-based content management systems.

In addition to providing a broad range of storage-related services to its subscribers, cloud storage solution providers sometimes also provide their subscribers with the option to activate and subscribe to third party storage-related services, which are preferably presented to the subscriber as part of the overall integrated storage solution. For ease of use and customer convenience, it has been desirable for the cloud storage solution provider to offer its subscribers integrated billing and usage reports. However, third party storage services providers tend to change their business rules (e.g., billing rates/price model, etc.) over time. Unfortunately, unless corrected, this tends to create a disparity between the billing/usage information that is available to the user, at a given point in time, and the actual amounts that are ultimately billed to the user at the end of a given billing cycle.

Existing solutions have taken one of two approaches, neither of which is optimal. Under the first approach, the cloud storage solution provider requires that the subscriber establish a separate, direct billing and management relationship with the third party storage services provider(s). This approach is undesirable because it wholly deprives the subscriber of the convenience of a single billing/usage statement.

Under the second approach, the cloud storage solution provider is required to manually update or patch its software as soon as it learns of the fact that a particular third party storage services provider has changed its billing model or pricing. This approach is undesirable because of the inefficiency and delay inherent in manually updating billing policies across what could be numerous third party providers.

Therefore, there is a need for the cloud storage solution provider to be able to dynamically and automatically update third party business model/rules which does not suffer from the aforementioned drawbacks. Specifically, there is a need for an improved system and method for providing centralized usage and billing information to subscribers receiving services from a plurality of service providers.

### SUMMARY OF THE INVENTION

Disclosed and claimed herein is a system and method for providing centralized billing and usage information relating to services provided by a plurality of service providers. In one embodiment, the method includes providing a cloud storage instance executable on a client-side server of the subscriber, where the cloud storage instance is configured to allow the subscriber to access services, over a network, provided by the cloud storage solution provider, as well as by one or more third party storage services providers. The method includes providing a shared-access storage configured to be accessible, over the network, by the cloud storage solution provider, the third party storage services provider and the subscriber. The method further includes receiving, over the network from the shared-access storage, billing policy information from the third party storage services provider relating to services provided by the third party storage services provider via the cloud storage instance.

The method further includes generating at least one of a centralized usage report and a centralized billing report for the subscriber based on the billing policy information received from the third party storage services provider, wherein the generated centralized usage/billing report contains usage and/or billing information corresponding to services that have been provided by the cloud storage solution provider, as well as by the third party storage services provider. The generated centralized usage/billing report is then stored by the cloud storage solution provider in the shared-access storage, after which it is provided from the shared-access storage device to the client-side server of the subscriber in response to a request from the subscriber.

Other aspects, features, and techniques of the invention will be apparent to one skilled in the relevant art in view of the following description of the exemplary embodiments of the invention.

### BRIEF DESCRIPTION OF THE DRAWINGS

The features, objects, and advantages of the present invention will become more apparent from the detailed description set forth below when taken in conjunction with the drawings in which like reference characters identify correspondingly throughout and wherein:

FIG. 1 illustrates an exemplary shared-access billing and usage consolidation system configured in accordance with the principles of the invention; and

FIG. 2 is a process for providing centralized billing and usage information relating to services provided by a plurality of service providers, in accordance with the principles of the invention.

### DETAILED DESCRIPTION OF THE EXEMPLARY EMBODIMENTS

### Overview of the Disclosure

The present disclosure relates generally to providing usage and billing information relating to cloud storage services provided by a plurality of service providers. In response to a subscriber inquiry, a client-side cloud storage instance accesses a shared-access storage to retrieve a centralized usage and billing report relating to services provided to the subscriber by a plurality of service providers, including a cloud storage solution provider and one or more third party service providers.

In certain embodiments, the centralized usage and billing report is automatically and periodically generated based on billing policy information received by the shared-access storage from the one or more third party services provider, and contains usage and/or billing information corresponding to services provided by both the cloud storage solution provider and by the one or more third party storage services providers. Additional details and features of the invention are set forth below.

As used herein, the terms “a” or “an” shall mean one or more than one. The term “plurality” shall mean two or more than two. The term “another” is defined as a second or more. The terms “including” and/or “having” are open ended (e.g., comprising). Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner on one or more embodiments without limitation. The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

In accordance with the practices of persons skilled in the art of computer programming, the invention is described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the invention are essentially the code segments to perform the necessary tasks. The code segments can be stored in a processor readable medium or transmitted by a computer data signal. The “processor readable medium” may include any medium that can store information. Examples of the processor readable medium include an electronic circuit, a semiconductor memory device, a ROM, a flash memory or other non-volatile memory, a floppy diskette, a CD-ROM, an optical disk, a hard disk, etc.

The term “server” means a functionally-related group of electrical components (e.g., processor, memory, network interface, etc.) such as a computer system in a networked environment which may include both hardware and software components, or alternatively only the software components that, when executed, carry out certain functions.

The term “storage” means hardware and software components that operate collectively to receive, store, maintain and provide access to digital data, such as data records, files and/or other data objects.

### Overview of an Exemplary Cloud Storage Environment

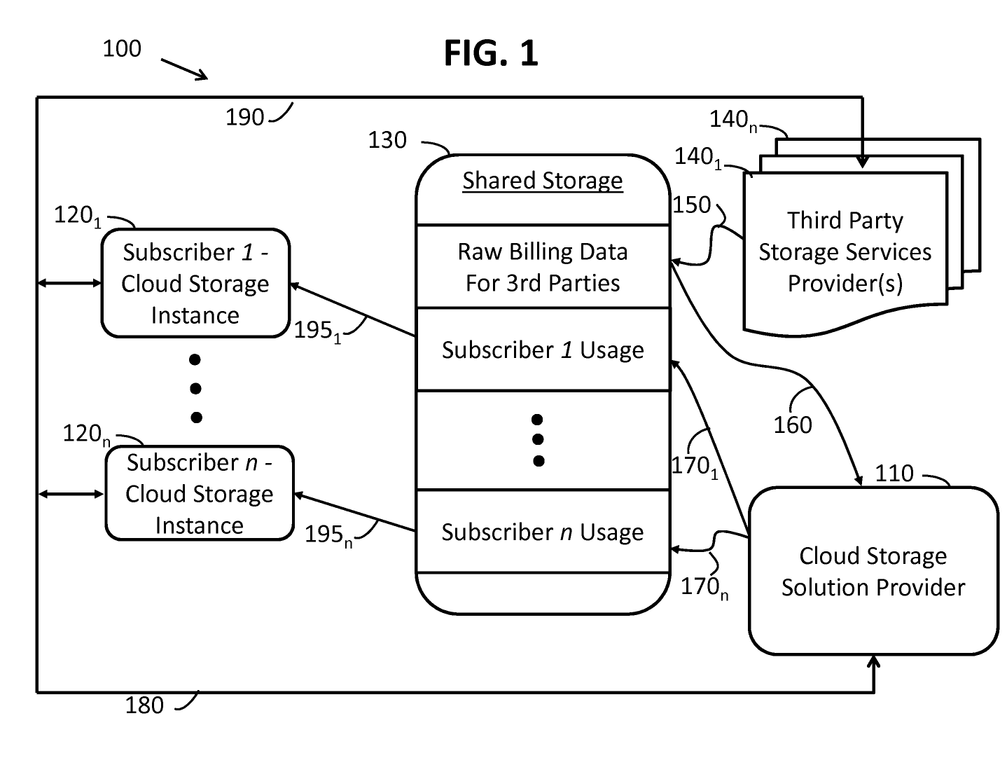

FIG. 1 depicts one embodiment of a centralized billing and usage information system 100, configured in accordance with the principles of the invention. As shown, system 100 comprises a cloud storage solution provider 110 which provides cloud storage services to a plurality of subscribers 1201-120n (collectively “120”). While in certain embodiments, the cloud storage solution provider 110 may actually host the physical environment in which the digital data is locally arranged, in other embodiments the cloud storage solution provider 110 may be situated between a third party hosting service and the subscribers 120 and be able to provide a richer and more robust set of storage-related services than a third party hosting service alone may be able to provide.

The cloud storage solution provider 110 makes its storage services available to the subscribers 120 by virtue of providing and allowing a cloud storage instance to be run on one or more client-side devices for each of the subscribers 120. A cloud storage instance may be in the form of a web service application programming interface (API) or a client-side application that utilize the API, such as cloud desktop storage, a cloud storage gateway or Web-based content management systems. A subscriber may be the end user of such a cloud storage instance, or may be an administrator, whereby a plurality of users interact with the cloud storage instance via the administrator and an administrator-provided interface.

The system 100 of FIG. 1 further includes a shared storage 130 which is configured to be individually and separately accessible by each of one or more third party storage services provider(s) 1401-140n (collectively “140”), the cloud storage solution provider 110 and any subscribers 120 running the above-described cloud storage instance, as provided by the cloud storage solution provider 110. In one embodiment, the shared storage 130 may be logically configured as a separate cloud storage “bucket” hosted on one or more third party servers.

Continuing to refer to FIG. 1, in one embodiment the third party storage services provider(s) 140 populate the shared storage 130 with raw billing data and/or policy information corresponding to the services that are provide by a particular one of the third party storage services provider(s) 140. In certain embodiments, the third party storage services provider(s) 140 may only have write access to a logical portion of the shared storage 130 that is dedicated to storing such third party information, e.g., a bucket dedicated to third party billing and policy information. In the event a particular one of the third party storage services provider(s) 140 changes the billing and/or policy information corresponding to its services, that third party storage services provider 140 would then over-write its previous billing/policy information stored in the shared storage 130, e.g., in the third party information bucket by providing current billing and/or policy information 150.

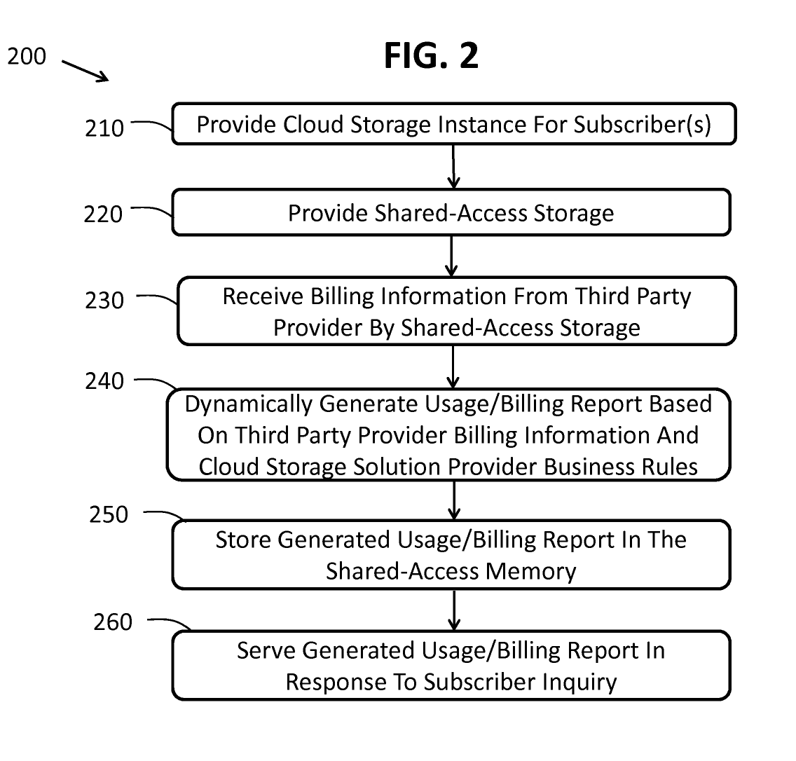

Cloud storage solution provider 110 is also provided with access to shared storage 130. Unlike third party storage services providers, however, the cloud storage solution provider 110 preferably has both read and write access. For example, in certain embodiments, the cloud storage solution provider 110 may have read access to at least the logical portion (bucket) of the shared storage 130 containing the third party information so that the cloud storage solution provider 110 can request and be provided with current third party billing and/or policy information 160. In addition, the cloud storage solution provider 110 preferably has write access to one or more additional logical portions (buckets) of the shared storage 130 in order to provide corresponding usage/billing data 1701-170n (collectively “170”) for each of the various subscribers 120. The process for how this is done is described in detail below with respect to FIG. 2.

With respect to the subscribers 120, each subscriber is preferably able to access the storage services provided by the cloud storage solution provider 110 via a cloud storage instance, as described in detail above (network connection 180). In addition, one aspect of the present invention is to further allow subscribers to activate and subscribe to third party storage-related services via the same cloud storage instance used to access the storage services provided by the cloud storage solution provider 110 (network connection 190). In this fashion, the cloud storage solution provider 110 may present an overall integrated storage solution to its subscribers 140 using a single cloud storage instance.

Finally, the subscribers 120 are also provided with access to shared storage 130. However, access for subscribers may preferably be limited to only that portion (bucket) of the shared storage which contains that subscriber's 120 own usage/billing information. In this fashion, each subscriber 120 may request and receive a centralized report 195 of their current usage/billing information.

Referring now to FIG. 2, depicted is one embodiment of a process 200 for providing centralized billing and usage information relating to services provided by a plurality of service providers using the system 100 of FIG. 1. In particular, process 200 begins at block 210 with a cloud storage solution provider (e.g., provider 110 of FIG. 1) providing a cloud storage instance that is executable on a client-side server of a subscriber (e.g., subscriber 140). Again, as noted above, the cloud storage instance may be in the form of a web service application programming interface (API) or a client-side application that utilize the API, such as cloud desktop storage, a cloud storage gateway or Web-based content management systems. Regardless of form, it should be appreciated that the cloud storage instance executing on the client-side device of the subscriber should preferably be configured to enable the subscriber to access services, over a network, provided by the cloud storage solution (e.g., network connection 180 of FIG. 1), as well as by one or more third party storage services provider(s) (e.g., network connection 190 of FIG. 1).

Process 200 continues to block 220 where access to a shared storage (e.g., shared storage 130), over the network, is provided for each of the above-references cloud storage solution provider, third party storage services provider(s) and subscriber(s). In certain embodiments, access may be limited to only certain portions (buckets) of the shared storage, and access may be additionally limited to reading and/or writing to those certain portions. For example, the third party storage services provider(s) may be limited to writing information to a provider-specific portion (bucket) of the shared storage, while subscribers may be limited to reading from a subscriber-specific portion (bucket) of the shared storage.

Once the cloud storage instance of block 210 is running and the appropriate accesses of block 220 established, process 200 may then continue to block 230, at which point billing policy information may be received, by the shared storage, from the third party storage services provider(s). In certain embodiments, the billing policy information may be broadly comprised of billing rates and policies relating generally to the storage services respectively provided by such third party storage services provider(s). In certain embodiments, each such third party storage services provider may have a designated bucket or portion of the shared storage to which it may write such billing policy information. Additionally, in the event there is a change in its billing policy, a third party storage services provider may write such information to the designated portion of the shared storage, and thereby over-write any then-outdated information in the process.

Process 200 continues to block 240 where subscriber usage and/or billing reports may be generated, by the cloud storage solution provider, based on at least the billing policy information received from the third party storage services provider and based on one or more business rules of the cloud storage solution provider. By way of a non-limiting example, one type of a business rule that the cloud storage solution provider could implement includes charging a basic commission (e.g., percentage) for the billed usage (e.g., from a consolidated report provided by the third party storage provider). Another such business rule may be to change an amount to be charged to a subscriber after or in response to an agreement being reached with a particular subscriber. In this case, the information could be updated automatically and dynamically, without requiring an update to the software. Still another example of a business rule which the cloud storage solution provider could implement includes providing certain subscribers with free or reduced-cost trials, whereby subscribers would not be charged (or would be charged a reduced rate) for the third party service for some predefined period of time and/or up to some predefined amount of usage.

It should additionally be appreciated that the reports may be generated based on the actual measured usage of the various storage services used by the subscriber. While in one embodiment, such subscriber usage may be measured by the cloud storage solution provider for both services provided by the third party as well as for services provided directly by the cloud storage solution provider, in other embodiments subscriber usage of third party services may be measured by the respective third party storage services provider(s) and periodically reported to the shared storage.

In certain embodiments, such billing reports may contain usage and/or billing information corresponding to services that have been provided by the cloud storage solution provider, as well as by the third party storage services provider, and thereby represent a centralized account of all of the storage-services-related activities and accrued charges for a given subscriber, irrespective of whether the services where provided by the cloud storage solution provider or by the third party storage services provider. It should further be appreciated that such reports may be generated automatically and periodically by the cloud storage provider such that they are generally current with respect to subscriber usage and corresponding amounts to be billed.

In order for the measured third party usage and billing information to be assigned to the correct subscriber portion of the shared storage, in certain embodiments it may be preferably to designate the cloud storage solution provider as a primary account (or paying account) for each of the various third party storage services providers, and then to designate a ‘linked account’ for each of the various subscribers that are receiving such third party services. In certain embodiments, when usage of third party services occurs for a linked account, a corresponding charge accrues to the primary/paying account, as opposed to the individual linked account, and a consolidated report may be generated/provided by the third party storage services provider for services attributed to the primary account (by virtue of the ‘linked accounts’ that actually received those services). As such, by linking its subscribers to its own primary/paying account, the cloud storage solution provider is able to obtain a single, consolidated bill from the third party storage services provider for all of its subscribers, which in turn can be used to generate a centralized bill covering third party storage services used by the particular subscriber, as well as the storage services provided directly to the subscriber by the cloud storage solution provider.

Once generated, the centralized usage and/or billing report may be stored at block 250 by the cloud storage solution provider in a designed area of the shared storage such as, for example, to a portion or bucket of the shared storage which has been designated to the subscriber to which the usage and/or billing report pertains. From then on, subscribers may be provided with their usage and/or billing report via their cloud storage instance over a network connection with the shared storage, which may preferably be done in response to a request from the subscriber (block 260).

While the invention has been described in connection with various embodiments, it should be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for providing centralized billing and usage information relating to services provided by a plurality of service providers, wherein the method comprises the acts of:
providing, by a cloud storage solution provider to a subscriber, a cloud storage instance executable on a client-side server of the subscriber, wherein the cloud storage instance is configured for the subscriber to access services, over a network, provided by the cloud storage solution provider and by a third party storage services provider;
providing a shared-access storage configured to be accessible, over the network, to each of the cloud storage solution provider, the third party storage services provider and the subscriber;
receiving, over the network from the shared-access storage, billing policy information from the third party storage services provider relating to services available to the subscriber from the third party storage services provider via the cloud storage instance;
generating, by the cloud storage provider, at least one of a centralized usage report and a centralized billing report for the subscriber based on the billing policy information received from the third party storage services provider, wherein the generated at least one of the centralized usage report and the centralized billing report contains usage and/or billing information corresponding to services that have been provided by the cloud storage solution provider and by the third party storage services provider;
storing, by the cloud storage solution provider in the shared-access storage, the generated at least one of the centralized usage and the centralized billing report;
providing, over the network from the shared-access storage device to the client-side server of the subscriber, the generated at least one of the centralized usage report and the centralized billing report in response to a request from the subscriber.

2. The method of claim 1, wherein the cloud storage instance comprises one of a web service application programming interface (API), a client-side application configured to utilize said API, a cloud storage gateway and a web-based content management system.

3. The method of claim 1, wherein the shared-access storage comprises a cloud storage bucket hosted on one or more third party servers.

4. The method of claim 1, wherein the billing policy information comprises at least one of billing rates and policies under which storage services are provided by the third party storage services provider server.

5. The method of claim 1, wherein generating comprises generating the at least one of the centralized usage report and the centralized billing report by the cloud storage provider automatically and periodically.

6. The method of claim 1, wherein generating comprises generating, by the cloud storage provider, the at least one of the centralized usage report and the centralized billing report for the subscriber based on the billing policy information received from the third party storage services provider and further based on one or more business rules of the cloud storage solution provider.

7. The method of claim 6, wherein the one or more business rules comprise at least one of charging a basic commission on services provided by the third party storage services provider, changing an amount to be charged to a subscriber in response to an agreement being reached with the subscriber, and providing the subscriber with a free or reduced-cost trial services available to the subscriber from the third party storage services provider server via the cloud storage instance.

8. A shared-access system configured to provide centralized billing and usage, the system comprising:
a cloud storage solution provider server coupled to a network;
a cloud storage instance executable on a client-side server of a subscriber, wherein the cloud storage instance is configured for the subscriber to access services, over a network, provided by the cloud storage solution provider server and by a third party storage services provider server;
a shared-access storage configured to be accessible, over the network, to each of the cloud storage solution provider server, the third party storage services provider server and the client-side server of the subscriber, wherein the cloud storage solution provider server is configured to:
receive, over the network from the shared-access storage, billing policy information from the third party storage services provider server relating to services available to the subscriber from the third party storage services provider server via the cloud storage instance,
generate at least one of a centralized usage report and a centralized billing report for the subscriber based on the billing policy information received from the third party storage services provider server, wherein the generated at least one of the centralized usage report and the centralized billing report contains usage and/or billing information corresponding to services that have been provided by the cloud storage solution provider server and by the third party storage services provider server, and
store, in the shared-access storage, the generated at least one of the centralized usage and the centralized billing report, wherein the generated at least one of the centralized usage report and the centralized billing report is accessible by the client-side server over the network from the shared-access storage device.

9. The system of claim 8, wherein the cloud storage instance comprises one of a web service application programming interface (API), a client-side application configured to utilize said API, a cloud storage gateway and a web-based content management system.

10. The system of claim 8, wherein the shared-access storage comprises a cloud storage bucket hosted on one or more third party servers.

11. The system of claim 8, wherein the billing policy information comprises at least one of billing rates and policies under which storage services are provided by the third party storage services provider server.

12. The system of claim 8, wherein the at least one of the centralized usage report and the centralized billing report is generated automatically and periodically by the cloud storage provider server.

13. The system of claim 8, wherein the cloud storage provider server is configured to generate the at least one of the centralized usage report and the centralized billing report for the subscriber based on the billing policy information received from the third party storage services provider server and further based on one or more business rules applied by the cloud storage solution provider server.

14. The system of claim 13, wherein the one or more business rules comprise at least one of charging a basic commission on services provided by the third party storage services provider, changing an amount to be charged to a subscriber in response to an agreement being reached with the subscriber, and providing the subscriber with a free or reduced-cost trial services available to the subscriber from the third party storage services provider server via the cloud storage instance.
